(19) United States
(12) Patent Application Publication
(10) Pub. No.: US 2015/0321145 A1
(43) Pub. Date: Nov. 12, 2015

(54) Internally Heated Urea Reactor/Injector For Use With SCR Emissions Control Device

(71) Applicant: Southwest Research Institute, San Antonio, TX (US)

(72) Inventor: Gordon J. J. Bartley, San Antonio, TX (US)

(21) Appl. No.: 14/271,385

(22) Filed: May 6, 2014

(51) Int. Cl. B01D 53/94

(52) U.S. Cl. CPC B01D 53/9431

(57) ABSTRACT

A method of treating NOx-containing exhaust from an internal combustion engine of an automotive vehicle. Urea solution is stored on-board the vehicle and delivered to a reactor/injector unit. The reactor/injector unit is operable to thermally decompose the urea solution into reductant gases suitable for direct application to an SCR catalyst without further reaction. The reactor/injector unit injects these reductant gases into the exhaust line upstream the SCR catalyst, which reacts them with the NOx in the exhaust.

### TECHNICAL FIELD OF THE INVENTION

This invention relates to internal combustion engines, and more particularly to injecting a urea-based reductant into a selective catalytic reduction (SCR) device used for reducing undesired emissions from such engines.

### BACKGROUND OF THE INVENTION

Polluting emissions from internal combustion engines are increasingly subject to regulation. These regulations have led to the use of a wide variety of emissions control technologies.

One approach to reducing regulated emissions is selective catalytic reduction (SCR). SCR is typically used to reduce oxides of nitrogen (NOx) emissions in lean burn engine exhaust, such as diesel exhaust. SCR methods mix a reductant with the engine exhaust, and flow this mixture through a special catalyst. The reductant sets off a chemical reaction within the catalyst that converts NOx in the exhaust into nitrogen, a natural component of air.

For SCR applications that are not necessarily automotive, several reductants are currently used. These reductants include anhydrous ammonia, aqueous ammonia or urea. Pure anhydrous ammonia is toxic and difficult to safely store, but needs no further conversion to operate within an SCR catalyst. It is typically favored by large industrial SCR applications. Aqueous ammonia must be dehydrated in order to be used, but it is safer to store and transport than anhydrous ammonia. Urea is the safest to store, but requires conversion to ammonia through thermal decomposition and hydrolysis before use as a reductant.

For automotive SCR applications, a solution of automotive-grade urea is typically used as the reductant source. For this application, the urea solution is sometimes referred to as diesel exhaust fluid (DEF) or AdBlue in Europe.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates an engine having an SCR aftertreatment system in accordance with the invention.

FIG. 2 illustrates the reactor/injector of FIG. 1 in further detail.

### DETAILED DESCRIPTION OF THE INVENTION

The following invention is directed to a urea reactor/injector for use with selective catalytic reduction (SCR) emissions control for an internal combustion engine. The reactor/injector receives automotive urea solution. It is internally heated, and vaporizes and hydrolyzes the urea solution into a reductant gas ready for use with an SCR catalyst.

As stated in the Background, for automotive emissions control applications, SCR exhaust aftertreatment uses a reductant, which is typically a urea solution, to reduce polluting emissions. More specifically, SCR technology is designed to permit oxides of nitrogen (NOx) reduction reactions to take place in an oxidizing atmosphere.

SCR is “selective” because it reduces levels of NOx selectively to nitrogen using a reductant within a catalyst. The chemical reaction is known as “reduction” because the reducing agent (reductant), in this case ammonia (NH3), reacts with NOx to convert the pollutants into nitrogen and water.

Conventional automotive SCR systems inject a urea solution directly into the exhaust stream. Although SCR catalysts are capable of NOx reduction at relatively low temperatures of ≧150° C., significantly higher temperatures are required for optimal vaporization and hydrolyzation of the urea solution within the SCR catalyst. For example, one study has shown that only about 20% of urea decomposes at 330° C., and only about 50% decomposes at 400° C.

For thermal decomposition of urea, a simplified pathway is given in Equations (1) and (2) below. However, the actual pathway can be more complicated, as shown in Equations (3) through (12).

urea

NH₂—CO—NH₂(s)→NH₃(g)+HNCO(g) (1)

HNCO(g)+H₂O(g)→NH₃(g)+CO₂(g) (2)

Urea→NH₄⁺+NCO⁻ (3)

NH₄⁺→NH₃(g)+H⁺ (4)

NCO⁻+H⁺→HNCO(g) (5)

biuret

Urea+NCO⁻+H⁺→C₂H₅N₃O₂ (6)

biuret→urea+NCO⁻+H⁺ (7)

cyanuric acid (cya)

biuret+NCO⁻+H⁺→C₃H₃H₃O₃+NH₃(g) (8)

cya→3NCO⁻+3H⁺ (9)

ammelide

cya+NCO⁻+H⁺→C₃H₄N₄O₂+CO₂ (10)

ammelide→2NCO⁻+2H⁺+HCN(g)+NH(g) (11)

NCO⁻+H⁺+H₂O→NH₃+CO₂(g) (12)

In conventional automotive SCR systems, the multiple byproducts indicated in Equations (3) through (12) can lead to solid build up in the exhaust system and in the urea injector, and to SCR catalyst fouling. To avoid these problems, urea injection is not usually performed at lower temperatures. As a result, the full potential of an SCR catalyst for reduction of NOx is not realized.

As explained below, the reactor/injector of the present invention achieves the reaction of the urea solution into a reductant gas. In other words, vaporization and hydrolyzation of the urea solution is performed within the reactor/injector. The reactor/injector thereby provides a reductant gas into the SCR catalyst so that the SCR catalyst can operate to reduce NOx at lower temperatures.

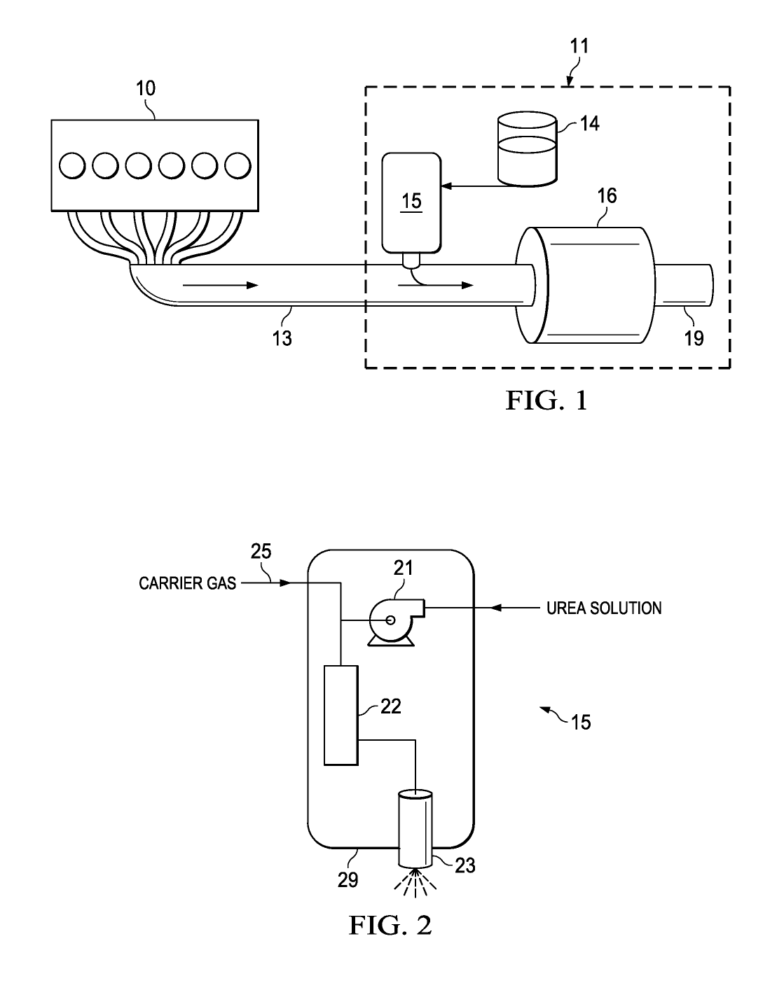

FIG. 1 illustrates an engine 10 having a SCR emissions control system 11 in accordance with the invention. Engine 10 may be any internal combustion engine that produces NOx-containing exhaust. The exhaust is exhausted from the engine 10 into a main exhaust line 13, where it is treated by the SCR system 11.

The SCR system 11 has three main elements: urea tank 14, reactor/injector 15, and SCR catalyst 16.

Urea tank 14 is an on-board tank to store a urea solution. An example of a typical urea solution is a non-toxic fluid composed of purified water and automotive grade aqueous urea, such as a 32.5% urea solution. Urea tank 14 may be placed in various locations, convenient for refilling and for avoiding freezing of the stored urea solution.

During vehicle operation, tank 14 delivers stored urea solution to reactor/injector 15. Tank 14 is periodically replenished by the vehicle operator.

Reactor/injector 15 is located such that it may inject its output into the exhaust stream upstream the input to SCR catalyst 16. SCR catalyst 16 may be located under the vehicle floorboard, or in the usual location for exhaust aftertreatment devices in automobiles, trucks, etc.

Reactor/injector 15 is further described below in connection with FIG. 2. As explained below, a feature of injector 15 is its internal heating capability. The urea solution that enters reactor/injector 15 is converted (thermalyzed and hydrolyzed) into an NH3 reductant directly suitable for application onto SCR catalyst 16.

SCR catalyst 16 may be any SCR type of exhaust aftertreatment device, such as are in commercial use today or to be developed. The reductant gas output of reactor/injector 15 is injected into the exhaust stream, upstream the inlet to the SCR catalyst 16. This mixture of reductant gas and engine exhaust is adsorbed onto the catalyst bed of SCR catalyst 16.

Examples of suitable SCR catalysts are those manufactured from various materials used as a carrier, such as titanium oxide or zeolites. Active catalytic components are usually oxides of base metals, such as vanadium, iron and copper.

Common geometries for SCR catalysts are honeycomb, plate and corrugated. The honeycomb type may be manufactured with an extruded catalyst or with a catalyst applied onto a ceramic carrier or substrate. Plate-type catalysts have lower pressure drops and are less susceptible to plugging and fouling than honeycomb types, but plate configurations are much larger and more expensive and often less efficient.

The treated exhaust from SCR catalyst 16 flows into the atmosphere via the engine tailpipe 19. In other embodiments, the aftertreatment system may contain additional treatment devices, such as a diesel particulate filter, not essential to the invention.

FIG. 2 illustrates the reactor/injector 15 of FIG. 1 in further detail. Reactor/injector 15 has three main components, contained within a housing 29: pump 21, reactor 22 and injector 23.

A feature of the invention is that these components are a compact integrated unit contained within housing 29. Housing 29 is suitable for installation in a vehicle, typically at the underside of the vehicle, near SCR catalyst 16. Thus, housing 29 is made from a rigid durable material, suitable to withstand under-body driving conditions.

Pump 21 is operable to move the urea solution from tank 14 into the reactor/injector 15. Pump 21 provides pressurization of the urea solution, with the specific pressurization being a function of system design. A suitable pressure is expected to be in the range of 10-60 psi.

The urea solution then enters reactor 22, which provides a “hot zone” chamber within reactor/injector 15. Within reactor 22, the urea is both thermolyzed and hydrolyzed. By “thermolized” is meant that the water in the urea solution evaporates (the water in the solution becomes water vapor) and the urea converts to NH3 and HNCO (gaseous ammonia and isocyanic acid). In other words, the urea solution is both vaporized and decomposed. By “hydrolyzed” is meant that the HNCO reacts with the water vapor to form NH3 and CO2.

Heating of the chamber within reactor 22 may be provided by various means. The primary heat source may be an electrical heater. Heat exchange can be provided by various means such as by a heated recirculating fluid.

Vaporization of the urea solution within reactor 22 may be accomplished by various means. In the example of FIG. 2, a pressurized carrier gas is introduced into reactor 22 via a carrier gas input line 25. The gas input line 25 joins with the output of pump 21, wherein the urea solution mixes with the carrier gas. The acceleration introduced by the carrier gas results in vaporization of the urea solution.

A specific example of a suitable vaporization means within reactor 22 might be similar to that of some water vaporizers. In these vaporizers, a carrier gas is accelerated through a critical orifice. The liquid stream (here, a urea solution) then enters the high velocity gas stream where it is broken into fine droplets.

Reactor 22 is heated to an optimum temperature for conversion of the urea solution into a reductant gas mixture with the desired chemical characteristics. It is expected that this temperature will be above the melting temperature of urea, which is 135 degrees C. Optimal operation is expected to be within a range of 150-500 degrees C.

The output of reactor 22 is a gaseous mixture of NH3, CO2 and water. This mixture is stable in the gas phase, and is injected into the exhaust stream by gas injector 23. Gas injector 23 may be implemented with any one of various gas injection devices.

As indicated above in connection with FIG. 1, the point of injection by gas injector 23 is into exhaust line 13 upstream of SCR catalyst 16. The injection point is such that there is mixing of the exhaust gas and the reductant gases. Ideally, there is sufficient mixing such that a uniform mix is provided to the SCR catalyst 16. The temperature of the exhaust gas at the injection point is preferably 135 degrees C. or higher to prevent recrystallization of the reductant gases.

The gaseous mixture injected by injector 23, now a component of the exhaust gas stream, can proceed to react with NOx within SCR catalyst 16. The SCR reaction can occur at low temperatures, such that only the SCR catalyst's formulation determines the catalyst activity rather than its temperature. Specifically, the use of reactor/injector 15 allows the use of an SCR catalyst 16 having an operating temperature as low as 135 degrees C.

Thus, a feature of reactor/injector 15 is that the production of the reductant within reactor/injector 15 occurs at a high temperature, and independently of the temperature required for operation of SCR catalyst 16. With this high temperature production of the reductant, chemical byproducts that would otherwise cause injector and SCR catalyst fouling are avoided. Thus, unlike conventional methods, which inject urea, the injection of reductant gas from reactor/injector 15 can occur at low temperatures.

What is claimed is:

1. A method of treating NOx-containing exhaust exiting an internal combustion engine of an automotive vehicle via an exhaust line, comprising:
storing a urea solution in a tank on board the vehicle;
delivering the stored urea to a reactor/injector unit operable to thermally decompose and hydrolyze the urea solution into a reductant gases suitable for direct application to an SCR catalyst without further reaction and further operable to inject the reductant gases into the exhaust line at an injection point;
placing a selective catalytic reduction (SCR) unit on the exhaust line, downstream the injection point, operable to react the reductant gases with NOx in the exhaust.

2. The method of claim 1, wherein the temperature of the exhaust gas at the injection point is 135 degrees C. or higher.

3. The method of claim 1, wherein the SCR catalyst is operable to reduce NOx at temperatures as low as 135 degrees C.

4. The method of claim 1, wherein the injector unit has at least the following components: a pump, a heated reactor chamber and a gas injector.

5. The method of claim 4, wherein the pump is operable to receive the urea solution and to deliver pressurized urea solution to the reactor chamber.

6. The method of claim 4, wherein the reactor chamber is operable to thermolyze and hydrolyze the urea solution, thereby forming a gaseous mixture of NH3, CO2 and water.

7. The method of claim 4, wherein the reactor chamber is heated by means of a recirculating fluid and an electrical heater.

8. The method of claim 1, wherein the reactor/injector receives a carrier gas operable to vaporize the urea solution.
